(19) United States
(12) Patent Application Publication
(10) Pub. No.: US 2013/0233986 A1
(43) Pub. Date: Sep. 12, 2013

(54) APPARATUS FOR SUPPORTING MOBILE PHONES, ELECTRONIC TABLETS AND CAMERAS

(71) Applicant: ISTABILIZER, LLC, Kamas, UT (US)

(72) Inventor: Noah Rasheta, Kamas, UT (US)

(73) Assignee: iStabilizer, LLC, Kamas, UT (US)

(21) Appl. No.: 13/868,012

(22) Filed: Apr. 22, 2013

Related U.S. Application Data
(60) Provisional application No. 61/643,797, filed on May 7, 2012.
(60) Provisional application No. 61/749,826, filed on Jan. 7, 2013.

(51) Int. Cl. G03B 17/56

(52) U.S. Cl. CPC G03B 17/561
USPC 248/205.1; 248/274.1

(57) ABSTRACT

A stabilizing attachment for use with a portable electronic device, such as a mobile phone, electronic tablet, camera or other such electronic device that may be used to obtain an image, may include an engagement element for holding a mobile phone, electronic tablet, camera or other portable electronic device. The engagement element may include a first member and a second member substantially parallel to one another for holding the portable electronic device. An adjustment element may enable adjustment of the first member relative to the second member to accommodate different sizes of mobile phones, electronic tablets, cameras or other portable electronic devices. The stabilizing attachment may also include a coupling element for securing the engagement element and any portable electronic device held thereby to another support, such as a tripod, a glass mountable device, a mobile unit or the like.

### CROSS-REFERENCE TO RELATED APPLICATION

Claims for priority to the benefit of the filing dates of U.S. Provisional Patent Application 61/749,826, titled “APPARATUS FOR SUPPORTING MOBILE PHONES, ELECTRONIC TABLETS AND CAMERAS,” filed on Jan. 7, 2013 (“the '826 Provisional Application”) and U.S. Provisional Patent Application 61/643,797, titled “APPARATUS FOR SUPPORTING MOBILE PHONES AND CAMERAS,” filed on May 7, 2012 (“the '797 Provisional Application”) are hereby made pursuant to 35 U.S.C. §119(e). The entire disclosures of the '826 Provisional Application and the '797 Provisional Application are, by this reference, hereby incorporated herein.

### TECHNICAL FIELD

This disclosure relates generally to apparatuses for supporting and/or stabilizing portable electronic devices, such as mobile telephones, electronic tablets and cameras for taking still photos and video. This disclosure also relates to methods for stabilizing portable electronic devices during filming.

### BACKGROUND OF RELATED ART

Existing devices for holding mobile phones or thin profile cameras in a stable and steady position during picture shooting have not been adequate. Conventionally, tripods have been used to hold conventional still and video cameras steady; a fastener on the tripod is typically secured to a universal receptacle in a body of the camera. The universal receptacles with which conventional tripods typically mate are, however, too large for use with state-of-the-art mobile telephones and thin profile cameras.

Attachments for supporting and stabilizing mobile phones have typically been inflexible, and their use has been limited to specific types of mobile phones. For example, two devices currently on the market can only be used with the IPHONE4® available from Apple, Inc. They are not compatible with other mobile phones.

Moreover, some current stabilizing attachments for mobile phones will not work if a protective case is in place over the mobile phone. When such a stabilizing attachment is used, removal of a protective case is undesirably required.

### SUMMARY

An accessory that may be used to support and stabilize mobile phones, electronic tablets, cameras and other portable electronic devices is disclosed. Such an accessory is referred to herein as a “stabilizing attachment” and as a “mount.” A stabilizing attachment that incorporates teachings of this disclosure may be adjusted to enable its use with a variety of different types of portable electronic devices, and with portable electronic devices of a plurality of different sizes and configurations.

A stabilizing attachment may be configured to eliminate, minimize or compensate for shaking, vibration and other undesirable movements of a mobile phone, electronic tablet, camera (e.g., a thin profile camera that lacks a standard tripod mount, etc.) or other portable electronic device during filming. In some embodiments, the stabilizing attachment may enable smooth, uninterrupted movement of a mobile phone, electronic tablet, camera or other portable electronic device relative to a subject while filming the subject; e.g., while shooting video.

Moreover, a stabilizing attachment may provide a support for electronic display devices, such as a mobile phone, electronic tablet, camera or other such device to enable hands-free support of such a device while viewing electronic displays provided by the device. As used herein, “electronic tablet” may include any electronic display device, including, without limitation, electronic devices marketed under the following trademarks: IPAD®, IPAD® mini, KINDLE® and NOOK®.

A stabilizing attachment may be configured to be supported by a surface (e.g., a tabletop, the ground, etc.), or it may be secured to and support by another object, such as a tripod, a monopod, glass (e.g., a window, a windshield, etc.), a mounting device (which may, in turn be secured to another object, such as a helmet, a surfboard, a snowboard, a skateboard, or the like), a dolly, a counterbalance or any other object that may be useful for supporting, carrying or transporting a camera during filming.

In a specific embodiment, a stabilizing attachment for use with a mobile phone, electronic tablet, camera or another portable electronic device may include: an engagement element and an adjustment element. The engagement element may be configured to hold the mobile phone, electronic tablet, camera or other portable electronic device, and may include a first member and a second member that are substantially parallel to one another, and that are configured to engage opposite sides, or edges, or the portable electronic device. The adjustment element may enable adjustment of a distance between the first member and the second member of the engagement element and may hold the first member and second member of the engagement element securely against corresponding sides of a portable electronic device. Thus, the adjustment element may enable the stabilizing attachment to accommodate different sizes of mobile phones, electronic tablets, cameras or other portable electronic devices.

Methods for stabilizing portable electronic devices and methods for stabilized filming using portable electronic devices are also disclosed.

Other aspects, as well as features and advantages of various aspects, of the disclosure subject matter will become apparent to those of ordinary skill in the art through consideration of the ensuing description, the accompanying drawings and the appended claims.

### BRIEF DESCRIPTION OF THE DRAWINGS

FIGS. 1 and 2 are views of an embodiment of a stabilizing attachment configured for use with a mobile phone, electronic tablet, camera or another portable electronic device;

FIGS. 3A and 3B are perspective views of the embodiment of stabilizing attachment shown in FIGS. 1 and 2;

FIGS. 4 and 5 are component views of the embodiment of stabilizing attachment shown in FIGS. 1 and 2;

FIGS. 6 and 7 are views of another embodiment of a stabilizing attachment configured for use with a mobile phone, electronic tablet, camera or another portable electronic device;

FIGS. 8-11 are views of another embodiment of a stabilizing attachment configured for use with a mobile phone, electronic tablet, camera or another portable electronic device;

FIGS. 12, 13 and 14 are views of the embodiment of stabilizing attachment shown in FIGS. 1 and 2, showing the stabilizing attachment secured to a mobile phone;

FIGS. 15, 16 and 17 are views of the embodiment of stabilizing attachment shown in FIGS. 12-14, depicting an embodiment of a process for securing a mobile phone to the stabilizing attachment;

FIGS. 18, 19 and 20 are views of the embodiment of stabilizing attachment shown in FIGS. 12-14, in which the stabilizing attachment is, in turn, secured to a tripod;

FIGS. 21, 22 and 23 are views of the embodiment of stabilizing attachment shown in FIGS. 12-14, in which the stabilizing attachment is secured to a glass stabilization device;

FIGS. 24 and 25 are views of the embodiment of stabilizing attachment shown in FIGS. 12-14, in which the stabilizing attachment is secured to a monopod device;

FIGS. 26, 27 and 28 are views of the embodiment of stabilizing attachment shown in FIGS. 12-14, in which the stabilizing attachment is secured to a dolly;

FIGS. 29, 30 and 31 are views of an embodiment of a counter-balance stabilizing attachment;

FIGS. 32 and 33 are views of the embodiment of stabilizing attachment shown in FIGS. 29-31, showing a mobile phone secured to the stabilizing attachment; and

FIG. 34 is a view showing the mount embodiment shown in FIGS. 5-9 attached to a tripod and holding a portable electronic device.

### DETAILED DESCRIPTION

Various embodiments of stabilizing attachments for positioning a cellular telephone, electronic tablet, camera or other portable electronic device on a stable apparatus are disclosed. A stabilizing attachment may be configured to enable the production of still photos and/or videos that are stabilized. A stabilizing attachment may provide for hands-free support of a portable electronic device while enabling an individual to view a display provided by the portable electronic device. A stabilizing attachment may include a spring-loaded mechanism, so that the mobile phone, electronic tablet, camera or other portable electronic device can be easily secured onto the stabilizing attachment and removed from the stabilizing attachment. The spring-loaded mechanism enables different sizes of mobile phones, electronic tablets, cameras or other portable electronic devices to be attached to the stabilizing attachment and still be clamped firmly in place by tension in the spring.

The stabilizing attachment may include a connector, or a “support coupling element,” that enables the stabilizing attachment to be secured to and, optionally, supported by a variety of other apparatuses, which are collectively referred to herein as “supports.” As a non-limiting example, the coupling element of the stabilizing attachment may comprise a standard tripod receptacle, which may be configured and threaded to receive and retain a complementary element of a tripod, enabling the stabilizing attachment to be positioned on a tripod of any size and/or shape, as well as on a variety of other supports, such as a window mount, a monopod or the like. The support coupling element can also be fastened to a counter-balance unit that compensates for any vibration, shaking or other unwanted movement in shooting video images.

The use of a spring loaded mechanism, such as a clamp or other engagement member, in the manner recited by the appended claims is a novel approach to securing a mobile phone, electronic tablet, camera or any other portable electronic device to a support, such as a tripod. Moreover, by having a standard support coupling element, such as a tripod thread, on the stabilizing attachment, the stabilizing attachment can be mounted to a variety of different types of tripods or other supports and, thus, adapt a mobile phone, electronic tablet, camera or another portable electronic device for stabilized support and mounting to such supports.

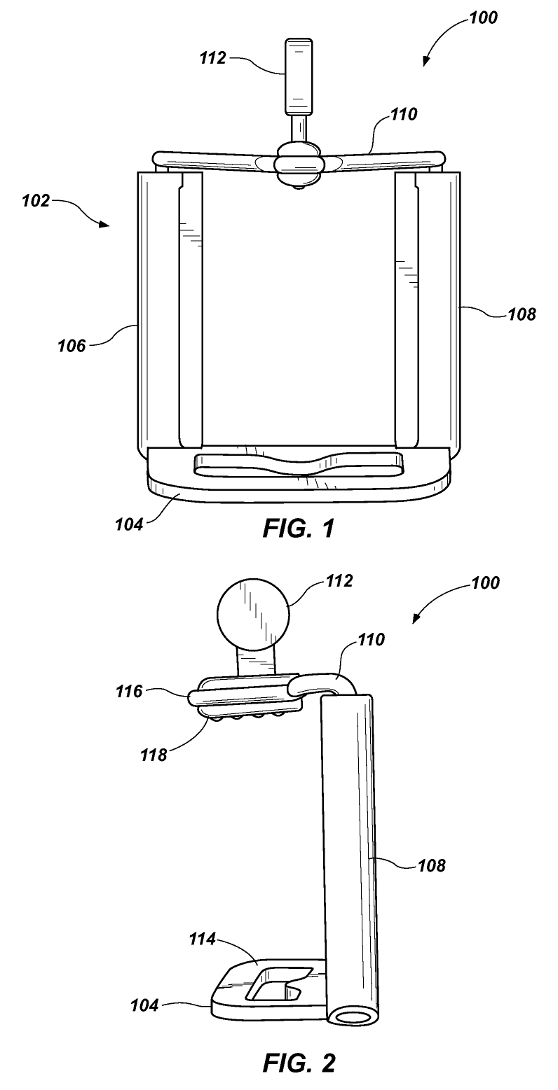

Referring to FIG. 1, a frontal view of an embodiment of a stabilizing attachment 100 is shown. Stabilizing attachment 100 includes an engagement member 102, which, as illustrated, may include a base 104—an embodiment of a “second member” of engagement element 102—and two parallel side arms 106 and 108, each of which is also referred to herein as an “elongated element,” extending transversely from base 104 (e.g., at right angles with base 104, etc.). An attachment piece 110, which is an embodiment of a “first member” of engagement element 102, is connected to the tops of arms 106 and 108. A tab 112 may protrude from an opposite side of attachment piece 110 from the side of attachment piece 110 that faces base 104. Tab 112 may enable an individual to pull attachment piece 110 away from base 104.

Looking now at FIG. 2, a side view of stabilizing attachment 100 is shown. It can be seen that base 104 extends transversely from (e.g., at a right angle from (outside of), etc.) arms 106 (FIG. 1) and 108 to provide a surface 114 on which one side, or edge, of the mobile phone, electronic tablet, camera or other portable electronic device may rest. Attachment piece 110 includes a support member 116 oriented substantially parallel with base 104 to support an opposite side of a mobile phone, electronic tablet, camera or other portable electronic device. In addition, support member 116 may include a cushion 118, which may comprise a compressible, resilient element that communicates with the surface(s) of attachment piece 110 that face(s) base 104. Such placement of cushion 118 may protect the mobile phone, electronic tablet, camera or other portable electronic device, and may help hold the mobile phone, electronic tablet, camera or other portable electronic device securely in place. In a specific embodiment (depicted by FIGS. 1 and 2), cushion 118 may comprise a lower portion of tab 112, which may be configured to fit into a slot (not seen here) of support member 116.

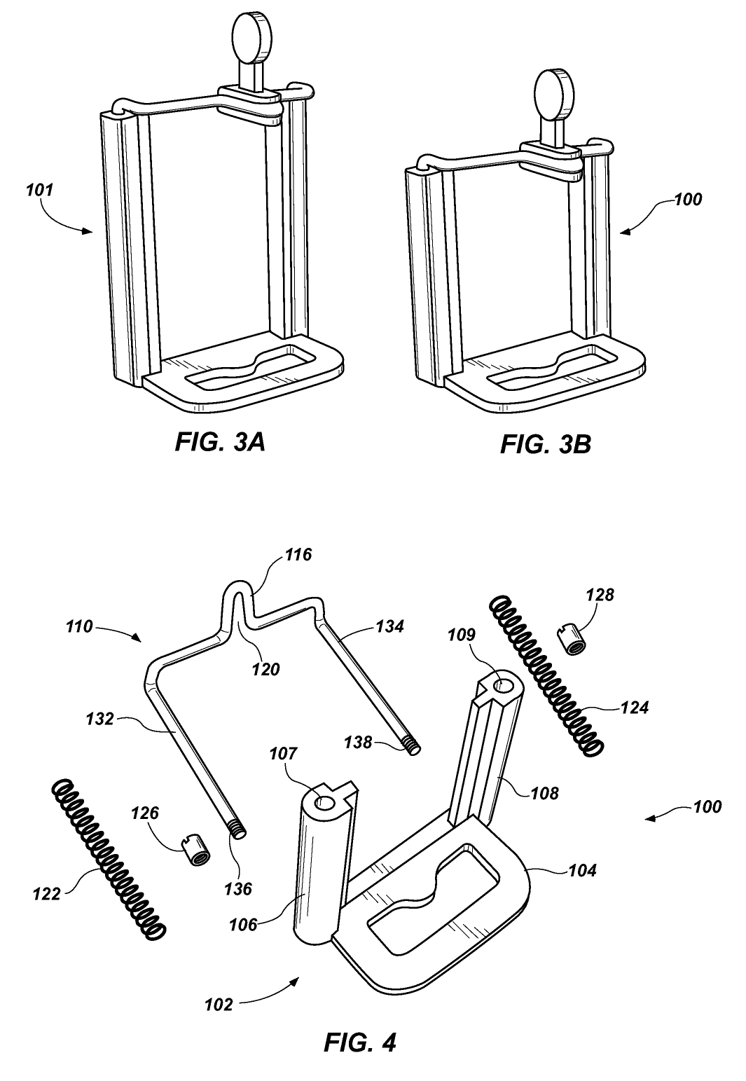

FIG. 3B provides a perspective view of stabilizing attachment 100. FIG. 3A provides a perspective view of a larger size mount 101 that may be used for larger mobile phones, such as a smart phone, a tablet phone or even a small electronic tablet.

With collective reference to FIGS. 1 through 3B, base 104, attachment piece 110, each arm 106, 108 and other features of stabilizing attachment 100 may be configured in a manner that enables stabilizing attachment 100 to receive a mobile phone, electronic tablet, camera or other portable electronic device in a manner without obstructing a view through a camera lens associated with a surface of the portable electronic device that faces the side of stabilizing attachment 100 on which each arm 106, 108 is located. In the embodiment depicted by FIGS. 1 through 3B, arms 106 and 108 may be spaced apart from one another in a manner that provides for an obstruction-free view from a camera lens of a portable electronic device.

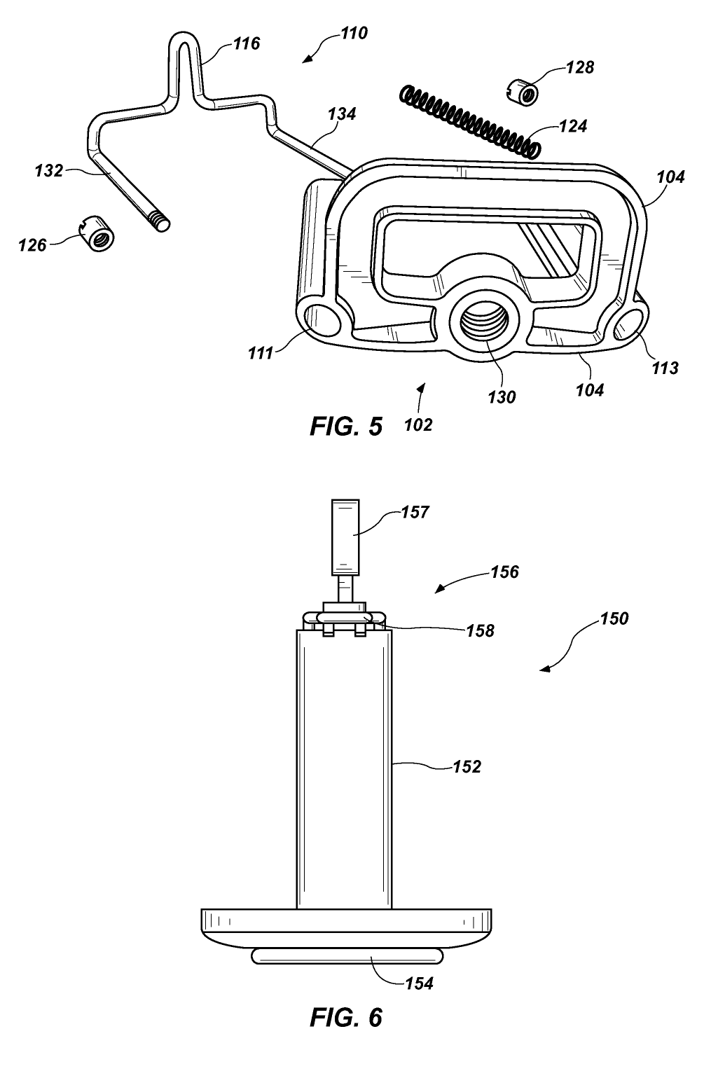

Referring next to FIGS. 4 and 5, a dismantled stabilizing attachment 100 is shown. Engagement element 102 is shown with its components separated from one another. In the depicted embodiment, each arm 106 and 108 is seen to be hollow, with cylindrical openings 107 and 109, respectively. Two springs 122 and 124 (e.g., coiled compression springs, etc.) are shown, as well as two spring retention elements 126 and 128. Attachment piece 110 is seen to have two legs 132 and 134 that extend transversely from (e.g., at right angles to, etc.) support member 116. Each leg 132, 134 may also be referred to herein as an “extendable element.” In the specific, but non-limiting embodiment shown in FIGS. 4 and 5, each leg 132 and 134 may have threaded ends 136 and 138 that are configured to be received by complementarily threaded receptacles of spring retention elements 126 and 128. Support member 116 on attachment piece 110 may be shaped to provide a slot 120, in which to insert a portion of tab 112.

In one embodiment, engagement element 102 comprises an integral piece of plastic, attachment piece 110 is made of formed metal and tab 112 is made of flexible rubber.

With continued reference to FIGS. 4 and 5, to assemble stabilizing attachment 100, legs 132 and 134 of attachment piece 110 are introduced into cylindrical openings 107 and 109 of arms 106 and 109 from the tops of arms 106 and 108, respectively. With legs 132 and 134 in cylindrical openings 107 and 109 of their respective arms 106 and 108, springs 122 and 124 are slid onto legs 132 and 134 of attachment piece 110. The upper end of each arm 106, 108 (and the upper ends of cylindrical openings 107 and 109) may be configured to retain the corresponding end of each spring 122, 124 in its respective cylindrical opening 107, 109 and arm 106, 108. Spring retention elements 126 and 128, which are configured to abut against the ends of springs 122 and 124 that are located closest to base 104 to hold springs 122 and 124 in place on legs 132 and 134 and within arms 106 and 108, respectively, are inserted into ends 111 and 113 of cylindrical openings 107 and 109 that open to a surface of base 104, as seen in FIG. 5, and screwed onto the threaded ends 136 and 138 of legs 132 and 134, respectively. Together, springs 122 and 124, legs 132 and 134, spring retention elements 126 and 128, arms 106 and 108 and any other members of engagement element 102 or of stabilizing attachment 100 that enable adjustment of the length of each arm 106, 108 and, thus, adjustment of the distance that base 104 and attachment piece 110 are spaced apart from one another form an “adjustment element” that works in conjunction with engagement element 102 of stabilizing attachment 100.

In FIG. 5, one can also see a support coupling element 130, which comprises a threaded opening in the center bottom of base 104 in the depicted embodiment. The threaded opening may be sized to fit any standard mount connector of most standard supports, such as a standard ¼″ tripod thread.

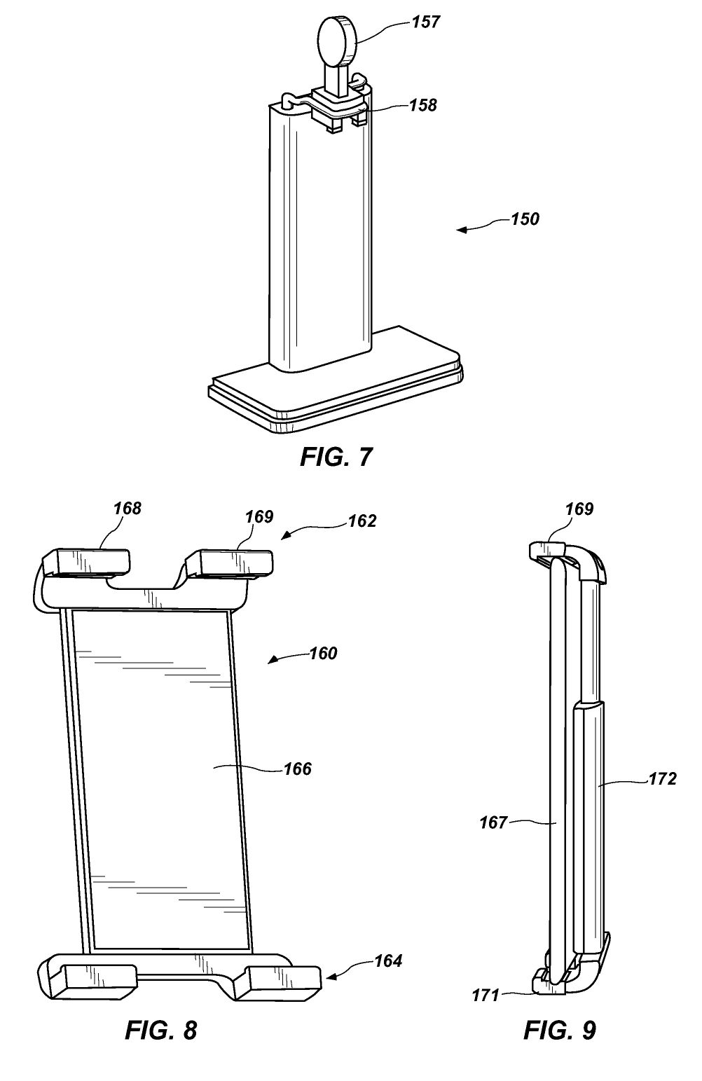

FIGS. 6 and 7 show a front view of another embodiment of stabilizing attachment 150 in which one vertical arm 152 is centered on stabilizing attachment 150 and extends from a base 154 to an attachment unit 156. Arm 152 may have one or more internal hollow cylinders (not shown), similar to cylindrical opening 107 of arm 106 of engagement member 102 of the embodiment of stabilizing attachment 100 shown in FIGS. 4 and 5, to provide for one or more legs (not shown) similar to leg 132 (FIGS. 4 and 5) and a biasing member, such as spring therein (not shown), similar to spring 122 (FIGS. 4 and 5), so as to bias attachment piece 156 towards base 154, similar to the biasing effect of springs 122 and 124 in stabilizing attachment 100, as shown in FIGS. 1 through 5. A tab (not shown) may be provided similar to tab 112 of stabilizing attachment 100 shown in FIGS. 1 through 5. A support member 158 is shown similar to support member 116 of stabilizing attachment 100, shown in FIGS. 1 through 5. Accordingly, stabilizing attachment 150 functions to stabilize and/or support a mobile phone, electronic tablet, camera or other portable electronic device in a manner similar to stabilizing attachment 100.

FIGS. 8, 9, 10 and 11 show another embodiment of stabilizing attachment 160, which may be used for mounting mobile phones, electronic tablets, cameras or other portable electronic devices. As seen in FIGS. 8 and 9, stabilizing attachment 160 has an upper clamping unit 162, or “attachment unit” or “first member,” and a lower clamping unit 164, or “base” or “second member,” connected by a biasing member 166. Upper clamping unit 162 may include two parallel fingers 168 and 169 that are disposed to extend outward to be able to engage one side of an electronic device (not shown). Likewise, lower clamping unit 164 may include two parallel fingers 170 and 171 that extend outward so as to enable engagement of another side of an electronic device.

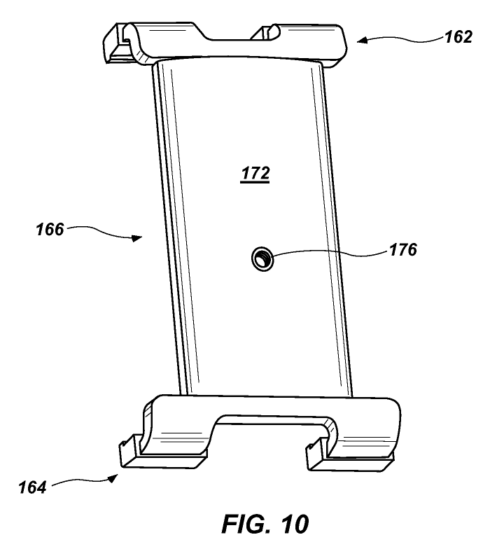

FIG. 10 shows a back view of stabilizing attachment 160 in which it can be seen that upper clamping unit 162, lower clamping unit 164 and biasing member 166 may be preassembled for ease in using stabilizing attachment 160. A threaded aperture 176 may be provided in the back 172 of biasing member 166 for mounting stabilizing attachment 160 on a tripod (not shown) or other support. In one embodiment, stabilizing attachment 160 may be composed of an integral molded plastic piece, with rubber tips attached to fingers 168 through 171 (FIG. 8). A rubber coating may also be applied to a front 167 (FIG. 9) of biasing member 166 to protect the portable electronic device that will be supported by stabilizing attachment 160.

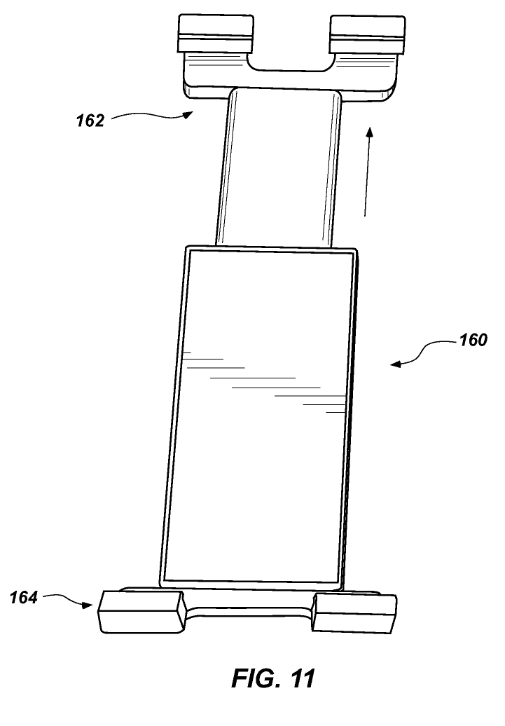

Referring to FIG. 11, upper clamping member 162 may be disposed for insertion into a hollow column (not shown) of lower clamping member 164. One or more biasing members (not shown), such as one or more springs, similar to springs 122 and 124 in stabilizing attachment 100 (see FIGS. 4 and 5) connect upper clamping member 162 and lower clamping member 164. In some embodiments, upper clamping member 162 and lower clamping member 164 may be pulled far enough away from each other to accommodate a portable electronic device having a dimension (e.g., a height, etc.) of about 8¼ inches. Of course, embodiments in which upper clamping member 162 and lower clamping member 164 are configured to be spaced different (smaller or larger) maximum distances apart from each other are also within the scope of this disclosure. Accordingly, stabilizing attachment 160 may function as a stabilizing or supporting device for a mobile phone, electronic tablet, camera or other portable electronic device in a manner similar to the embodiment of stabilizing attachment 100 depicted by FIGS. 1 through 5.

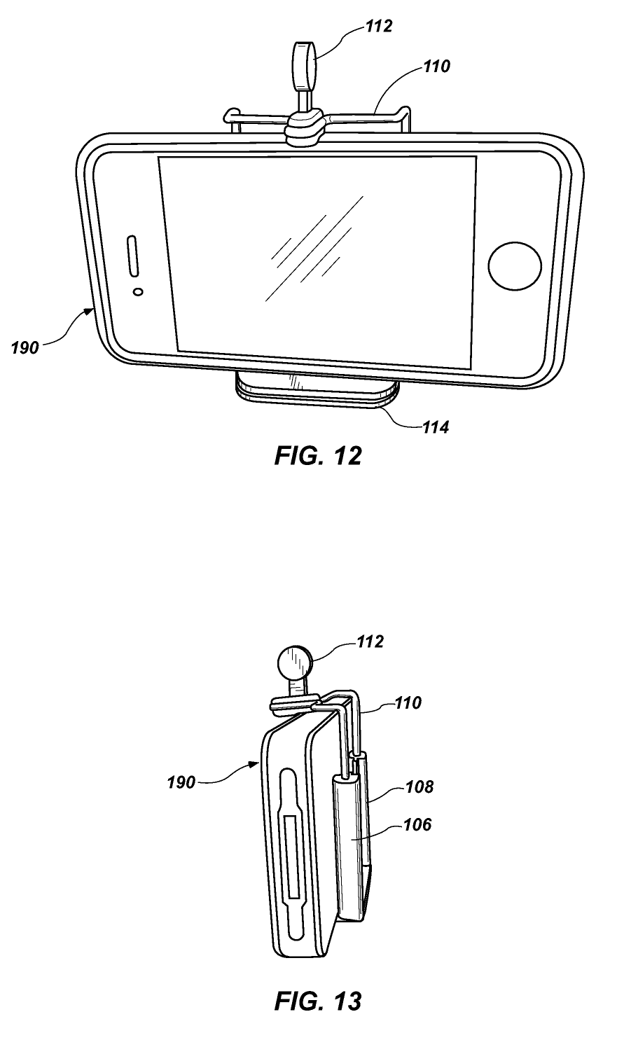

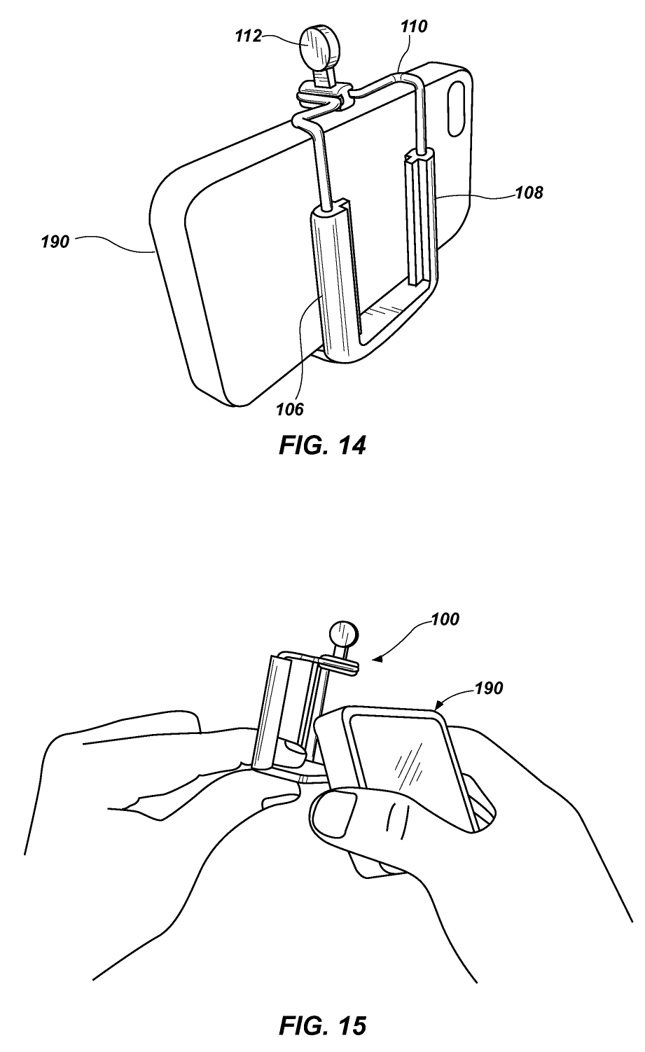

FIGS. 12, 13 and 14 show front, side and perspective views of a mobile phone 190 attached to the embodiment of stabilizing attachment 100 shown in FIGS. 1 through 5. Although a mobile phone 190 is illustrated by these and other figures, it should be understood that stabilizing attachment 100 and other embodiments of stabilizing attachments that fall within the scopes of the claims can be used with a variety of other embodiments of portable electronic devices. In FIGS. 12, 13 and 14, it can be seen that attachment piece 110, which is spring-loaded, can be raised upward by means of pulling tab 112 or other similar means, so that the mobile phone 190 will fit between support member 116 and a surface 114 of base 104, as shown in FIG. 2. There is a downward tension on attachment piece 110 exerted by springs 122 and 124 (FIG. 4) that causes mobile phone 190 to be firmly held in place, regardless of its size.

The use of a spring-loaded mechanism enables a stabilizing attachment (e.g., stabilizing attachment 100, etc.) to accommodate mobile phones, electronic tablets, cameras and other portable electronic devices of different shapes and/or sizes. The depicted embodiments of stabilizing attachments 100, 150 (FIGS. 6 and 7), 160 (FIGS. 8 through 11) are dimensioned to enable mounting of a mobile phone, electronic tablet, camera or other portable electronic device with a protective case. Typically, mobile phones, cameras or other portable electronic devices not wider than 2.75 inches can be positioned on stabilizing attachment 100. However, it should be understood that size is not an important variable, and stabilizing attachment 100 can be made larger to accommodate larger portable electronic devices.

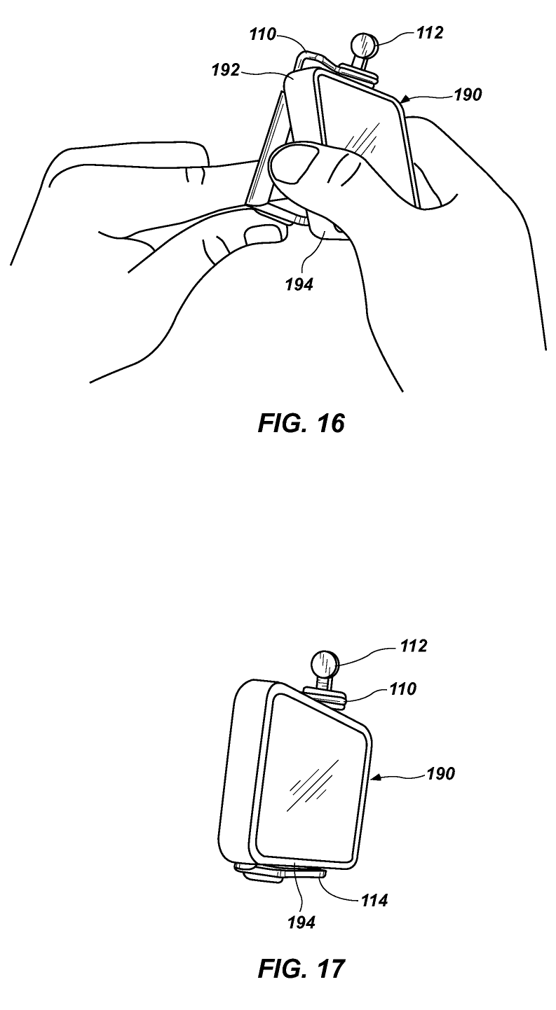

FIGS. 15, 16 and 17 show the steps in loading a mobile phone 190, electronic tablet, camera or other portable electronic device into a stabilizing attachment, such as stabilizing attachment 100. As seen in FIG. 15, mobile phone 190 is positioned at the front part of stabilizing attachment 100. In FIG. 16, mobile phone 190 is placed so that one side 192 of mobile phone 190 is in contact with the bottom of tab 112 that rests in a slot 120 (FIG. 4) in support member 116 of attachment piece 110. Pressure is exerted against attachment piece 110 causing it to move upward while increasing the tension on the springs (not shown here). As seen in FIG. 17, when attachment piece 110 has been moved upward sufficiently, then the other side 194 of mobile phone 190 may be moved into contact with surface 114 of base 104. Then mobile phone 190 is disposed completely within the opening formed between arms 106 and 108 (not seen here), attachment piece 110 and surface 114.

The pressure on mobile phone 190 and attachment piece 110 is then released, causing the springs connected to attachment piece 110 to pull attachment piece 110 firmly against side 192 of mobile phone 190. Mobile phone 190 may be released from stabilizing attachment 100 by again pulling up on tab 112 to remove the pressure being exerted by attachment piece 110 on mobile phone 190. Mobile phone 190 may then be removed from stabilizing attachment 100.

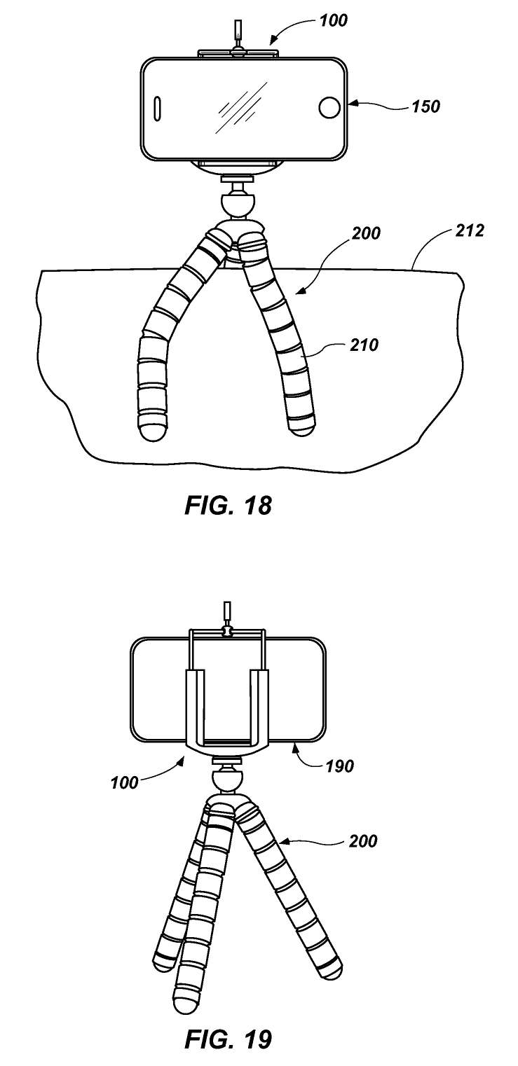

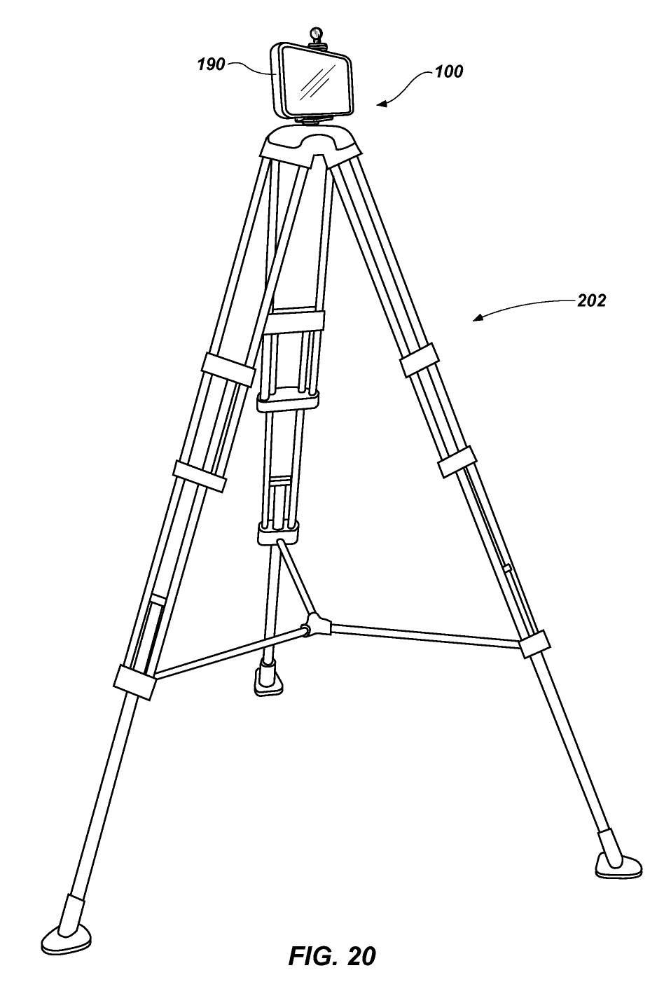

As seen in FIGS. 18 and 19, stabilizing attachment 100 may be fastened to a mini-tripod 200. Tripod 200 may have flexible legs 210 to conform to any surface, such as a chair back 212, so as to stabilize stabilizing attachment 100 and any mobile phone, electronic tablet, camera or other portable electronic device attached thereto. As mentioned above, stabilizing attachment 100 may be attached to tripod 200 by means of support coupling element 130. FIG. 20 shows stabilizing attachment 100 fastened to a full size tripod 202.

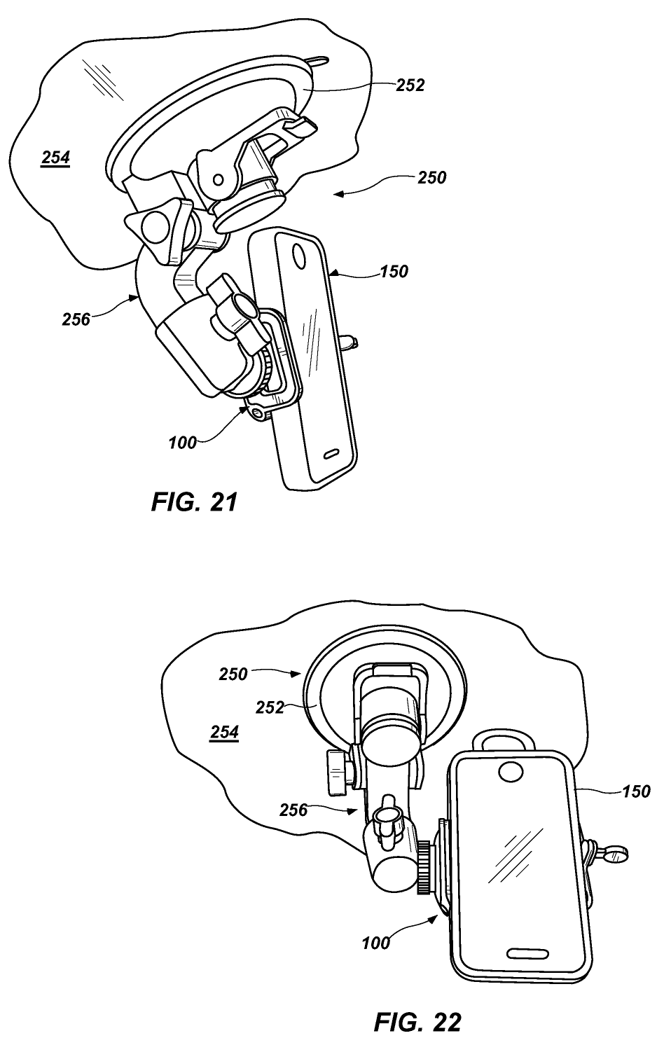

Next, looking at FIGS. 21 through 23, a glass stabilization unit 250 is shown to which stabilizing attachment 100 may be attached. In this embodiment, a suction member 252, such as a rubber piece, is pressed against glass or another smooth surface, such as an automobile windshield 254, to form a vacuum that holds stabilization unit 250 in place. Stabilizing attachment 100 is attached to an extension member 256 stemming from suction member 252 to enable stabilizing attachment 100 and the attached mobile phone 190, electronic tablet, camera or other portable electronic device to be positioned as desired to shoot single takes or videos through automobile windshield 254.

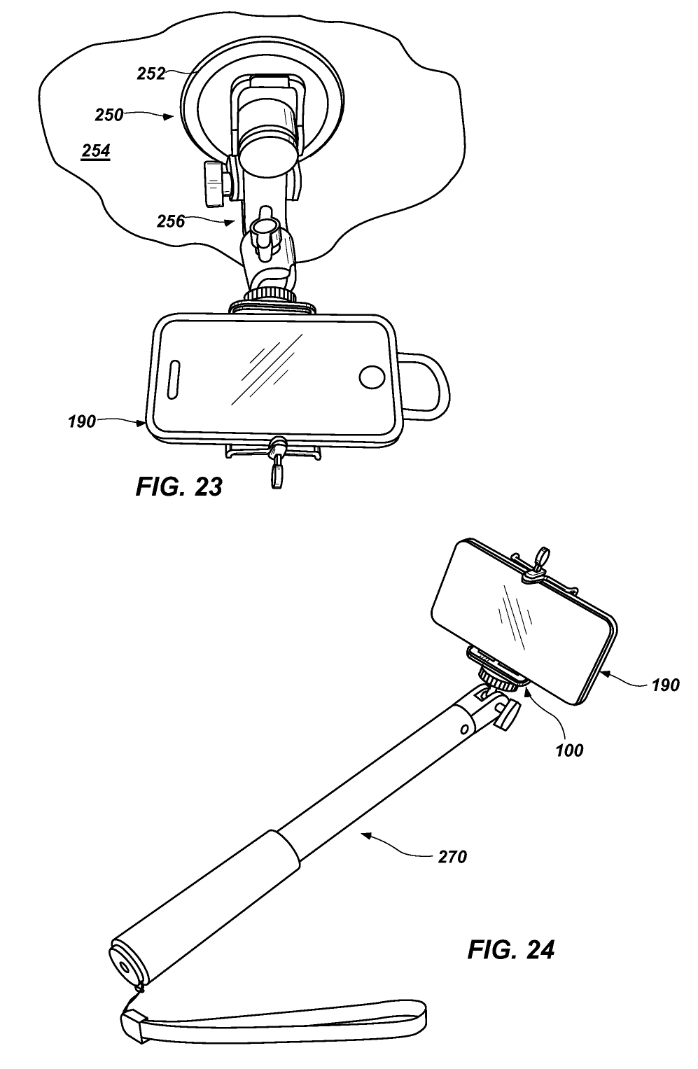

FIGS. 22 and 23 show that extension member 256 may be adjusted to shoot out automobile windshield 254 with mobile phone 190 disposed vertically or horizontally. Several other adjustments are provided on extension member 256 to place mobile phone 190 in whatever position may be desired.

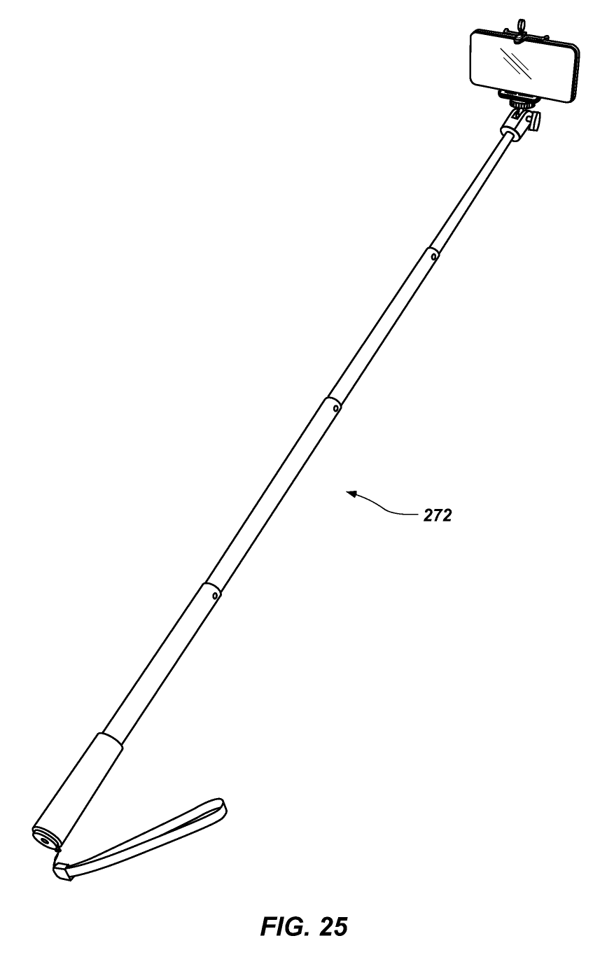

In FIGS. 24 and 25, a short monopod 270 and a long monopod 272 are shown, each with stabilizing attachment 100 and a mobile phone 190, electronic tablet, camera or other portable electronic device attached thereto. Typically either monopod has several telescoping sections to adjust its height or length. The use of monopods allows simple one-point stabilization for taking shots or video while frequently moving to different places and possibly rough terrain.

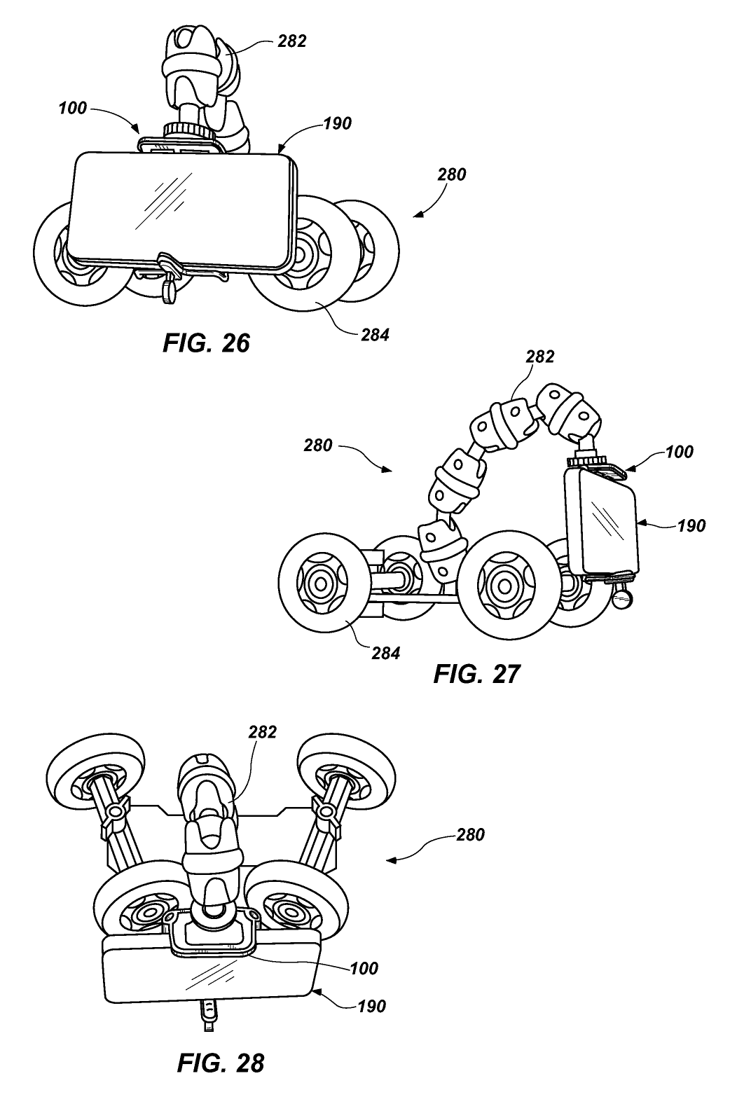

FIGS. 26-28 show a mobile unit, or dolly 280, with a flexible stem 282 protruding therefrom, as well as a stabilizing attachment 100 secured to flexible stem 282. A mobile phone 190, electronic tablet, camera or other portable electronic device may be attached to stabilizing attachment 100 and, thus, to dolly 280. Flexible stem 282 can be adjusted to hold mobile phone 190 in different positions.

Dolly 280 has a plurality of wheels 284 (four in the depicted embodiment) that enable it to use a flat surface for stability, while traversing the surface to take video or single shots on the same plane. Wheels 284 may be turned to move in different directions. Dolly 280 may be manually operated or driven by a remote-controlled motor.

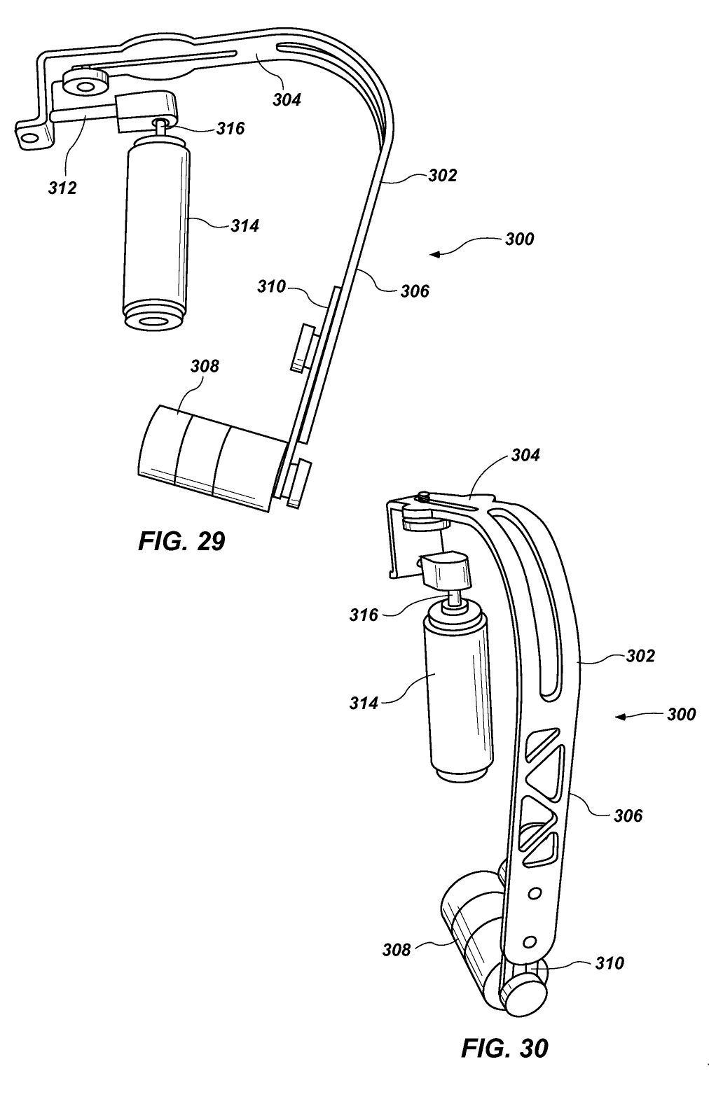

Referring now to FIGS. 29 and 30, a counter-balance attachment 300 is shown for stabilizing a stabilizing attachment and any mobile phone, electronic tablet, camera or other portable electronic device attached thereto against small hand movements to enable smooth videotaping. A curved bracket 302 includes an attachment section 304 to which a mobile phone, electronic tablet, camera or other portable electronic device may be attached and a balance section 306 carrying a weight 308 to counter-balance the weight of the mobile phone, electronic tablet, camera or other portable electronic device. Weight 308 is connected to balance section 306 by an adjustable bracket 310 that enables weight 308 to be extended further, thereby increasing leverage and counterbalancing effect.

At the distal end of attachment section 304 is a brace 312 having a grip 314 attached thereto by a pivotable gimbal 316 that tends to isolate small hand motions on grip 314 from attachment section 304. The combination of the counter-balance weight 308 and pivotable gimbal 316 tend to smooth out any movement of the mobile phone, electronic tablet, camera or other portable electronic device. This action is especially useful when the mobile phone, electronic tablet, camera or other portable electronic device is rapidly moved in various directions during fast action filming.

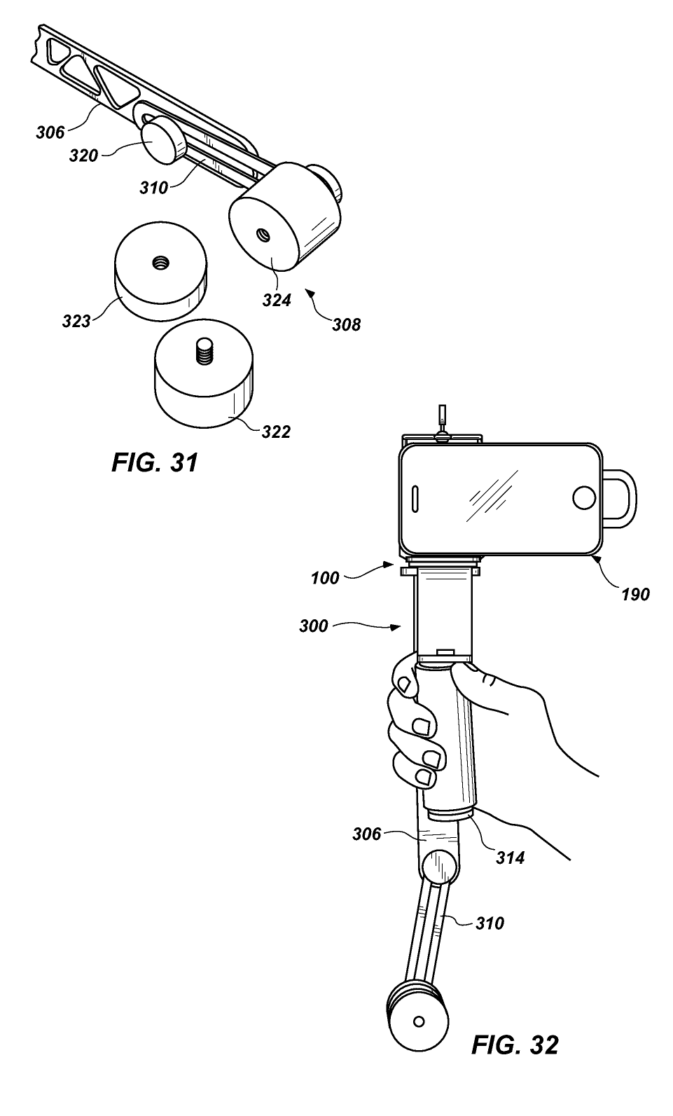

FIG. 31 shows the adjustable bracket 310 in more detail. A tension screw 320 attaches bracket 310 to counter-balance attachment 300 (FIGS. 29, 30, 32 and 33). Screw 320 may be loosened and the amount of extension of bracket 310 from balance section 306 may be adjusted to change the amount of leverage and counter-balance action. Weight 308 may be comprised of several smaller weights, such as weights 322 and 323 that can be screwed in main weight 324 to adjust the amount of weight being applied.

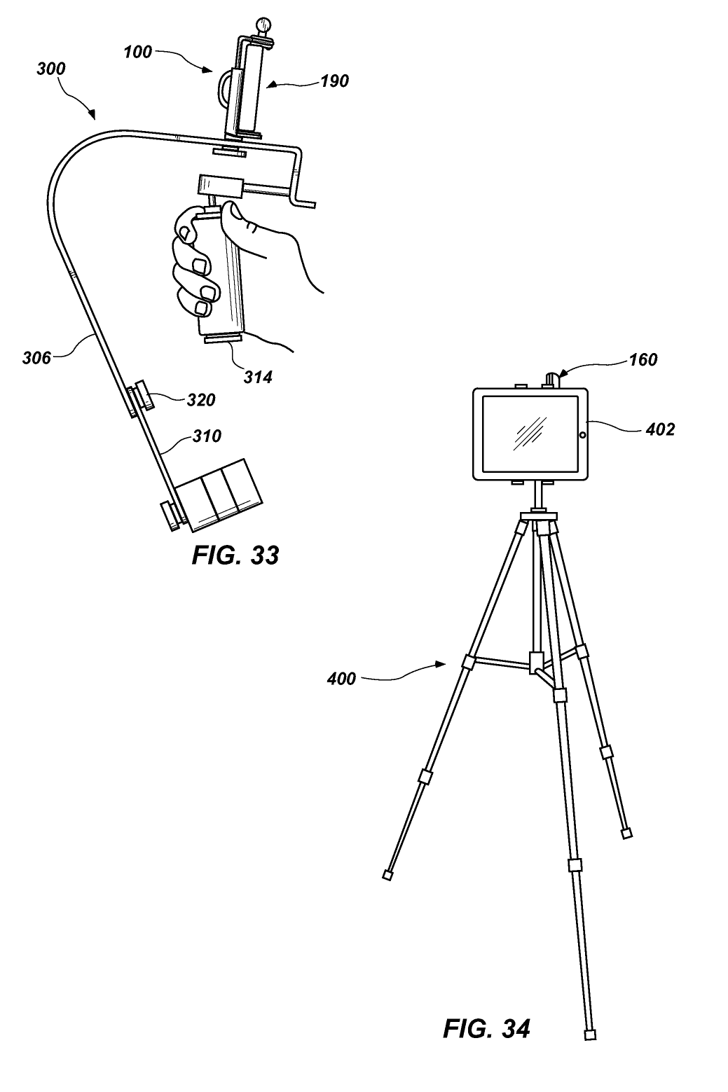

FIGS. 32 and 33 show the counter-balance attachment 300 with a stabilizing attachment 100 attached thereto and a mobile phone 190, electronic tablet, camera or other portable electronic device attached to stabilizing attachment 100. The apparatus may be manipulated by holding grip 314. As best seen in FIG. 32, bracket 310 may be pivoted around screw 320 at any angle up to at least 90 degrees from parallel with balance section 306. This adjustment enables the counter-balance action to compensate for off-center balance problems with respect to the mobile phone 190, electronic tablet, camera or other portable electronic device, as seen in FIG. 32.

As seen above, a stabilizing attachment may be configured to position a mobile telephone, electronic tablet, camera or other portable electronic device on a stable support to produce still photos and videos that are stabilized. The mount includes an engagement element, which may comprise a spring-loaded mechanism so that the mobile phone, electronic tablet, camera or other portable electronic device can be easily secured onto the stabilizing attachment and removed from the stabilizing attachment. The spring-loaded mechanism enables different sizes of mobile phones, electronic tablets, cameras or other portable electronic devices to be attached to the mount and still be clamped in firmly by the tension from the spring.

In addition, several embodiments of supports to which the stabilizing attachment can be secured are disclosed. A mini-tripod may be used having flexible legs that can grip nearly any surface or member. A glass mount may be attached to any stable glass piece, such as a windshield, so that a mobile phone, electronic tablet, camera or other portable electronic device can be mounted on a stabilizing attachment, which is in turn attached and manipulated by the glass mount. A monopod may be attached to a stabilizing attachment so that a mobile phone, electronic tablet, camera or other portable electronic device may be stabilized in almost any terrain. Further, a stabilizing attachment may be mounted on a mechanical dolly to support a mobile phone in any desired position as the dolly is moved to provide action for the photos or video. A unique counter-balance apparatus on which the stabilizing attachment and a mobile phone, electronic tablet, camera or other portable electronic device that has been mounted to the stabilizing attachment may include a gimbal and a counter-weight to smooth out or eliminate unwanted hand motions during action takes.

Referring to FIG. 34 stabilizing attachment 160 is shown connected to a tripod device 400 by a swivel member (not shown) so that an electronic display device 402, such as an IPAD® or other electronic tablet, may be supported for viewing.

Although the foregoing description sets forth many specifics, these should not be construed as limiting the scopes of any of the appended claims, but merely as providing information pertinent to some specific embodiments that may fall within the scopes of the appended claims. Features from different embodiments may be employed in combination. In addition, other embodiments of the disclosed subject matter may also lie within the scopes of the appended claims. All additions to, deletions from and modifications of the disclosed subject matter that fall within the scopes of the claims are to be embraced by the claims.

What is claimed:

1. Apparatus for stabilizing a portable electronic device for obtaining images by securing the portable electronic device to a support, comprising:
an engagement element for holding a mobile phone, electronic tablet, camera or other portable electronic device having a first member and a second member substantially parallel to the first member;
an adjustment element to enable adjustment of the first member and the second member relative to one another to accommodate different sizes of mobile phones, electronic tablets, cameras or other portable electronic devices; and
a support coupling element for coupling the apparatus for stabilizing the portable electronic device to a support.

2. The apparatus of claim 1, wherein the adjustment element comprises a spring.

3. The apparatus of claim 2, wherein the spring biases the first member towards the second member.

4. The apparatus of claim 3, wherein the spring exerts pressure on the first member towards the second member, thereby causing the first and second members to clamp firmly on the mobile phone, electronic tablet, camera or other portable electronic device.

5. The apparatus of claim 1, wherein the first member includes a leg disposed towards the second member, and the adjustment element comprises a spring mounted on the leg to bias the first member towards the second member.

6. The apparatus of claim 5, wherein the first member may be moved relative to the second member while under tension from the spring to enable different sizes of mobile phones, electronic tablets, cameras or other portable electronic devices to be mounted on the attachment unit.

7. The apparatus of claim 1, wherein the support coupling element comprises a threaded receptacle for accepting a threaded bolt or screw of the support.

8. Apparatus for mounting a mobile phone, electronic tablet, camera or other portable electronic device on a support, comprising:
a first member having a first extending piece;
a second member having a second extending piece;
an engagement member connected between the first member and the second member to exert a bias force on the first member toward the second member, whereby a mobile phone, electronic tablet, camera or other portable electronic device may be clamped firmly between the first extending piece and the second extending piece.

9. The apparatus of claim 8, wherein the engagement member comprises a spring connected between the first member and the second member to bias the first member towards the second member.

10. The apparatus of claim 9, wherein an extendable element is connected between the first member and the spring and an elongated element is connected between the second member and the spring.

11. The apparatus of claim 10, wherein the first member may be moved relative to the second member, or the second member may be moved relative to the first member to accommodate different sizes of mobile phones, electronic tablets, cameras or other portable electronic devices.

12. Apparatus for mounting a mobile phone, electronic tablet, camera or other portable electronic device to a support, comprising:
a base configured to support a side of a portable electronic device;
an elongated element with an opening therein protruding from a portion of the base configured to support the side of the portable electronic device;
an extendable element configured to fit in the opening of the elongated element;
an attachment piece parallel to the base; and
a spring attached between the elongated element and the extendable element to bias the attachment piece towards the base, thereby clamping on a mobile phone, electronic tablet, camera or other portable electronic device inserted between the base and the attachment piece.

13. The apparatus of claim 10, wherein the attachment piece may be moved a plurality of distances apart from the base to accommodate different sizes of mobile phones, electronic tablets, cameras or other portable electronic devices.

14. Apparatus for mounting a mobile phone, electronic tablet, camera or other portable electronic device to a support, comprising:
an engagement element for holding a mobile phone, electronic tablet, camera or other portable electronic device having a first member and a second member substantially parallel to one another,
an adjustment element to bias the first member toward the second member, to enable adjustment of a distance between the first member and the second member to enable the first member and the second member to receive and secure a plurality of sizes of mobile phones, electronic tablets, cameras or other portable electronic devices; and
a support coupling element for connecting the apparatus to a support.

15. The apparatus of claim 14, wherein the adjustment element includes a compression spring.

16. The apparatus of claim 14, wherein the support is a tripod.

17. The apparatus of claim 14, wherein the support is a glass-mounted attachment.

18. The apparatus of claim 14, wherein the support is a monopod.

19. The apparatus of claim 14, wherein the support is a counterweight balance device.

20. The apparatus of claim 14, wherein the support is a mobile dolly.

21. The apparatus of claim 14, further comprising:
a motion stabilizer configured to compensate for hand motion while obtaining an image with a mobile phone, electronic tablet, camera or other portable electronic device, including:
a curved, elongated bracket for attaching to a mobile phone, electronic tablet, camera or other portable electronic device;
an extension member attached at a distal end of the curved, elongated bracket;
a weight attached at the distal end of the extension member; and
an adjustment device on the extension member to adjust a position of the weight relative to the mobile phone, electronic tablet, camera or other portable electronic device.

22. The apparatus of claim 21, wherein the adjustment device is disposed to adjust a distance of the weight from the mobile phone, electronic tablet, camera or other portable electronic device.

23. The apparatus of claim 21, wherein the adjustment device is disposed to adjust an angle of the weight relative to the mobile phone, electronic tablet, camera or other portable electronic device.

24. The apparatus of claim 21, wherein the motion stabilizer further includes:
a stabilizing apparatus to connect the mobile phone, electronic tablet, camera or other portable electronic device to the curved elongated bracket.

25. The apparatus of claim 14, wherein the support comprises:
a mobile unit having a plurality of wheels, and
an attachment member for connecting a mobile phone, electronic tablet, camera or other portable electronic device to the mobile unit.

26. The apparatus of claim 25, wherein the attachment member is a flexible stem, enabling the mobile phone, electronic tablet, camera or other portable electronic device to be pointed in a plurality of directions.

27. The apparatus of claim 25, wherein the mobile unit is manually operated.

28. The apparatus of claim 25, wherein the mobile unit is motor driven.

29. The apparatus of claim 25, wherein the plurality of wheels may be turned to move in different directions.

30. The apparatus of claim 25, further comprising a stabilization apparatus to connect the mobile phone, electronic tablet, camera or other portable electronic device to the attachment member.
